(19) United States
(12) Patent Application Publication
(10) Pub. No.: US 2011/0317408 A1
(43) Pub. Date: Dec. 29, 2011

(54) LAMP HOLDER STRUCTURE

(75) Inventor: Chuan-Ying CHEN, Zhongli City (TW)

(73) Assignee: Himan International Co., Ltd.

(21) Appl. No.: 13/081,601

(22) Filed: Apr. 7, 2011

(30) Foreign Application Priority Data
Jun. 29, 2010 (TW) 99212282

(51) Int. Cl. F21V 21/00

(52) U.S. Cl. 362/217.14

(57) ABSTRACT

A lamp holder structure includes a slide groove at a central portion thereof for insertion of pins of a fluorescent tube, two oblique guide plates at two sides of an outer end of the slide groove, and a bell mouth defined between the two guide plates. Through the guide plates to form the bell mouth, the pins of the fluorescent tube can be inserted into the slide groove easily and conveniently, enhancing the efficiency of mounting the fluorescent tube.

### BACKGROUND OF THE INVENTION

1. Field of the Invention

The present invention relates to a lamp holder structure, and more particularly, to a lamp holder structure having guide plates at two sides of a slide groove for guiding pins of a fluorescent tube.

2. Description of the Prior Art

There are various lighting apparatuses on the market for different purposes. A fluorescent tube is widely used indoors or outdoors because of energy saving. The fluorescent tube has two pins at two ends thereof. When the pins are inserted into a lamp holder and electrified, the fluorescent tube will be lightened. A conventional lamp holder has a slide groove. When mounting or replacing a fluorescent tube, the user has to ascend a ladder. Besides, the pins are small in size and the slide groove is narrow in width. It is inconvenient and dangerous to mount or replace the fluorescent tube in the conventional lamp holder. Accordingly, the inventor of the present invention has devoted himself based on his many years of practical experiences to solve this problem.

### SUMMARY OF THE INVENTION

The primary object of the present invention is to provide a lamp holder structure for a fluorescent tube, which can facilitate pins of the fluorescent tube to be inserted into a slide groove.

In order to achieve the aforesaid object, the lamp holder structure comprises a slide groove at a central portion thereof for insertion of pins of a fluorescent tube, two oblique guide plates at two sides of an outer end of the slide groove, and a bell mouth defined between the two guide plates. Through the guide plates to form the bell mouth, the pins of the fluorescent tube can be inserted into the slide groove easily and conveniently, enhancing the efficiency of mounting the fluorescent tube.

Preferably, the guide plates can be disposed at either side of the open end of the slide groove.

Preferably, the number of the slide groove is one or two.

### BRIEF DESCRIPTION OF THE DRAWINGS

FIG. 1 is a perspective view according to a first embodiment of the present invention;

FIG. 2 is a front view according to the first embodiment of the present invention;

FIG. 3 is a schematic view showing the first embodiment of the present invention to connect with a fluorescent tube;

FIG. 4 is a schematic view showing the first embodiment of the present invention to disconnect with the fluorescent tube;

FIG. 5 is a schematic view showing a second embodiment of the present invention to connect with the fluorescent tube;

FIG. 6 is a schematic view showing the second embodiment of the present invention to disconnect with the fluorescent tube; and

FIG. 7 is a schematic view showing the present invention applied to a conventional lamp holder.

### DETAILED DESCRIPTION OF THE PREFERRED EMBODIMENTS

Embodiments of the present invention will now be described, by way of example only, with reference to the accompanying drawings.

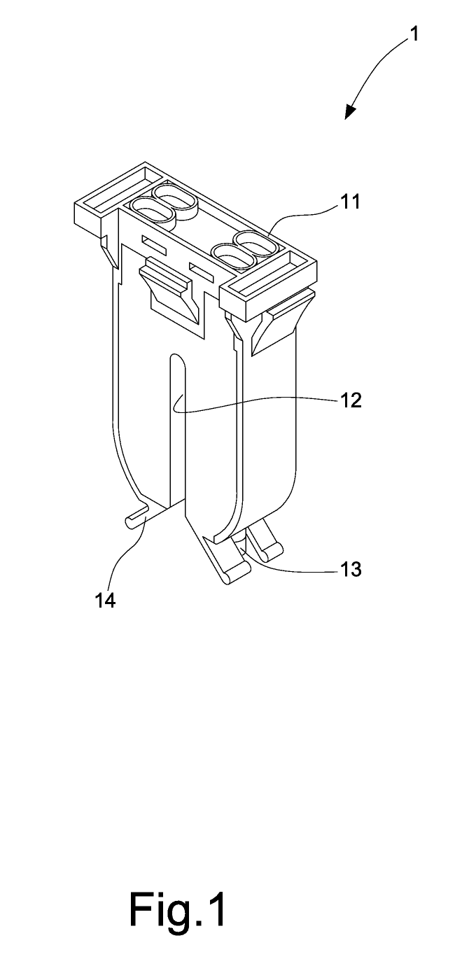

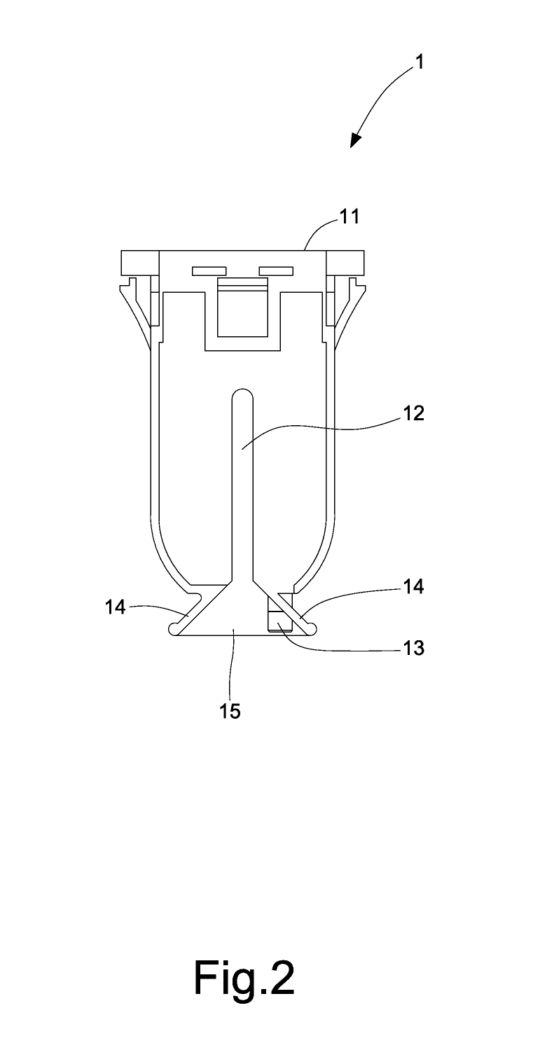

As shown in FIG. 1 and FIG. 2, a lamp holder 1 according to a preferred embodiment of the present invention comprises a connection end 11 at an upper end thereof, a slide groove 12 at a central portion thereof, two oblique guide plates 14 at two sides of an open end of the slide groove 12, and a bell mouth 15 defined between the two guide plates 14. In this embodiment, the lamp holder 1 is in a single groove configuration and comprises a press portion 13 which is developed by the applicant in an earlier application.

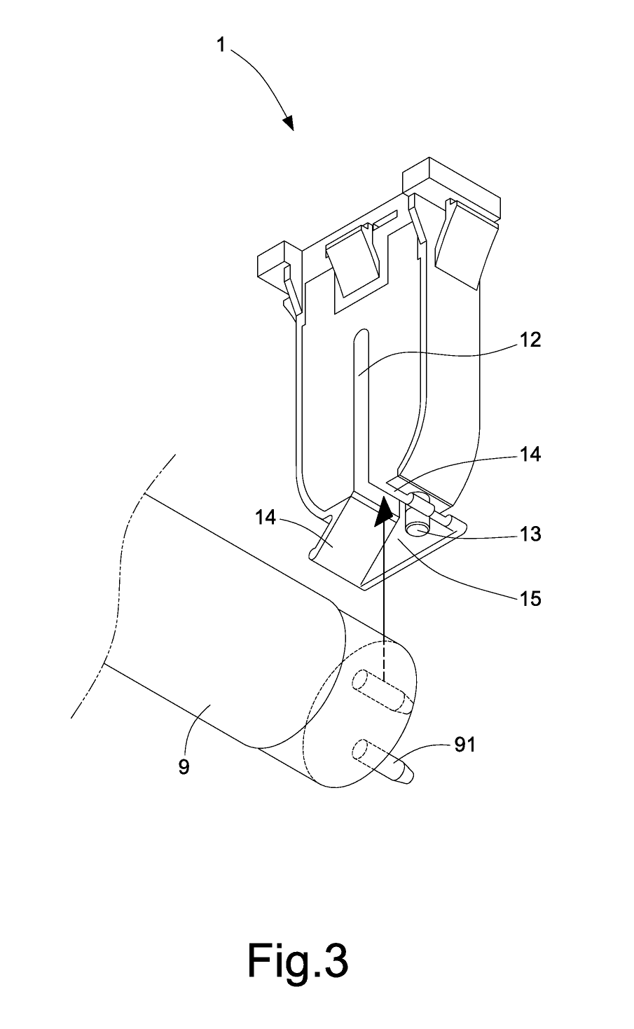

As shown in FIG. 3, two pins 91 of a fluorescent tube 9 are inserted in the slide groove 12. Either of the pins 91 approaches the bell mouth 15. No matter whether the pin 91 is aimed at the axis of the slide groove 12 or not, the pin 91 is placed in the range of the bell mouth 15 and moved inward. The pin 91 may be in contact with either of the guide plates 14 to be guided into the slide groove 12 so as to complete the assembly. Accordingly, through the bell mouth 15, the pin 91 can be mounted in the slide groove 12 with ease.

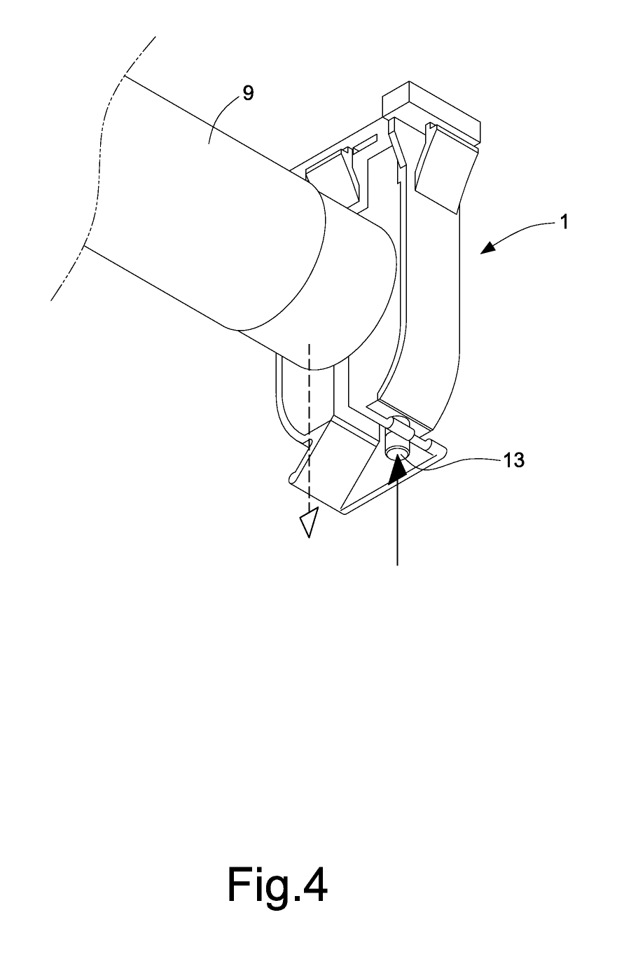

Referring to FIG. 4, when the user wants to disconnect the fluorescent tube 9 from the lamp holder 1, the user just presses the press portion 13 to release the engagement configuration inside so as to take out the fluorescent tube 9.

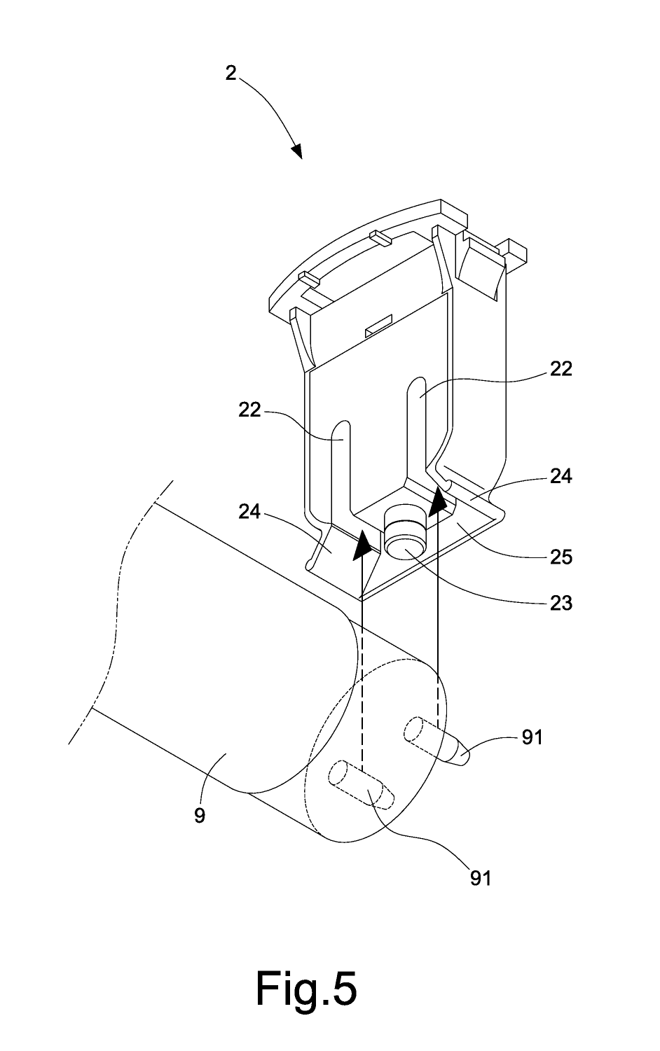

FIG. 5 shows another embodiment of the present invention in a dual-groove configuration. The lamp holder 2 has two slide grooves 22. Each slide groove 22 has an outer side provided with a guide plate 24. Two sides of each slide groove 22 may be provided with a guide plate 24, respectively. A bell mouth 25 is defined between the two guide plates 24. To practice the present invention, the two pins 91 of the fluorescent tube 9 are inserted in the two slide grooves 22, respectively. The pins 91 approach the bell mouth 25. No matter whether the pins 91 are aimed at the axis of the respective slide grooves 12 or not, the pins 91 are placed in the range of the bell mouth 25 and moved inward. The pins 91 may be in contact with either of the guide plates 14 to be guided into the slide grooves 22 so as to complete the assembly. Accordingly, through the bell mouth 25, the pins 91 can be mounted in the slide grooves 22 with ease.

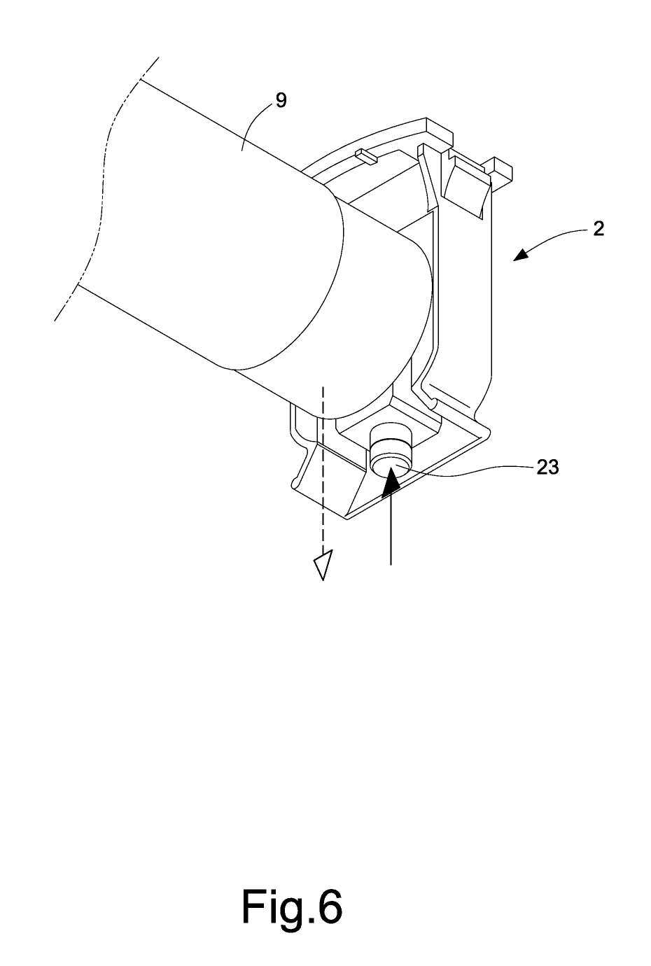

Referring to FIG. 6, when the user wants to disconnect the fluorescent tube 9 from the lamp holder 2, the user just presses the press portion 23 to release the engagement configuration inside so as to take out the fluorescent tube 9.

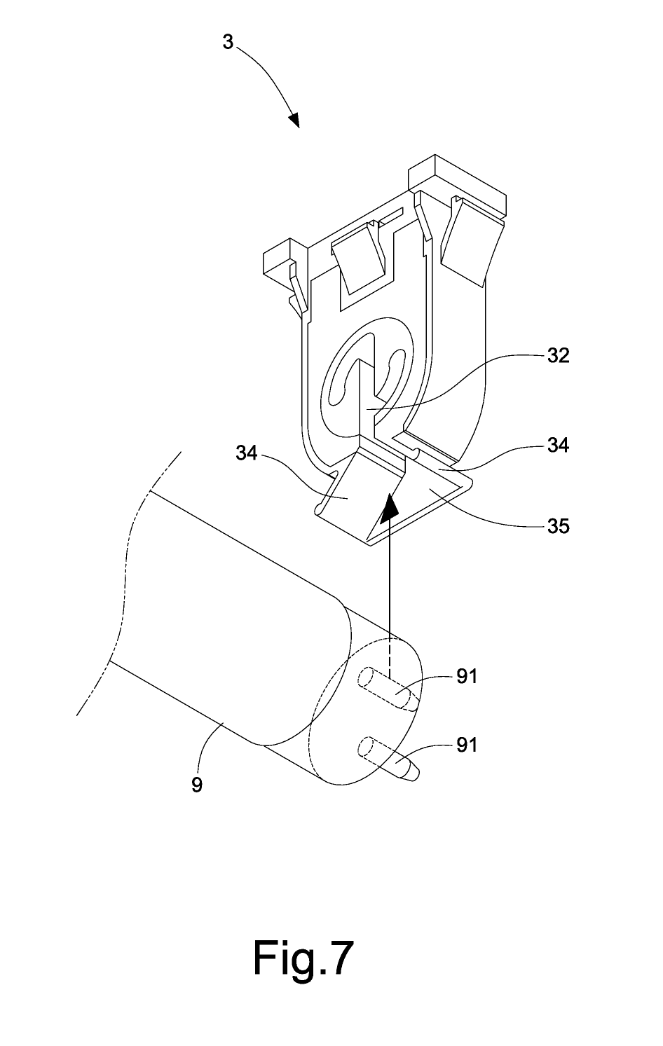

FIG. 7 shows that the present invention is applied to a conventional lamp holder 3 without the press portion. Two sides of a slide groove 32 are provided with two guide plates 34, and a bell mouth 35 is defined between the two guide plates 34 for the pins 91 to be inserted therefrom.

Thus, through the guide plates or the bell mouth of the present invention, the pins of the fluorescent tube can be inserted into the slide groove easily and conveniently, enhancing the safety when mounting or replacing the fluorescent tube.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A lamp holder structure, comprising a slide groove at a central portion thereof and an oblique guide plate at an outer end of the slide groove.

2. The lamp holder structure as claimed in claim 1, wherein the number of the guide plate is one and the guide plate is disposed at one side of the outer end of the slide groove.

3. The lamp holder structure as claimed in claim 1, wherein the number of the guide plate is two and the two guide plates are disposed at two sides of the outer end of the slide groove.

4. The lamp holder structure as claimed in claim 3, wherein a bell mouth is defined between the two guide plates at the two sides of the outer end of the slide groove.

5. The lamp holder structure as claimed in claim 1, wherein the number of the slide groove is one or two.
